(19) United States
(12) Patent Application Publication
(10) Pub. No.: US 2020/0242464 A1
(43) Pub. Date: Jul. 30, 2020

(54) INCREMENTAL AI FIRMWARE UPDATES USING IN-DEVICE TRAINING AND PEER-TO-PEER UPDATES

(71) Applicant: Sony Corporation, Tokyo (JP)

(72) Inventors: Michiro Hirai, Kanagawa (JP); Nikolaos Georgis, San Diego, CA (US)

(73) Assignee: Sony Corporation, Tokyo (JP)

(21) Appl. No.: 16/260,726

(22) Filed: Jan. 29, 2019

(51) Int. Cl. G06N 3/08; G06N 3/04

(52) U.S. Cl. CPC G06N 3/08; G06N 3/04

(57) ABSTRACT

An example embodiment facilitates determining and distributing incremental updates, via a peer-to-peer network, to Artificial Intelligence (AI) firmware algorithms running on embedded systems. The embedded systems include code for implementing the peer-to-peer network and for sharing locally determined updates to weights of classification layers of neural networks used to implement the AI firmware algorithms. The updates can also be locally adjusted and/or scheduled based on context information, such as embedded device location information, network status, and so on, and in accordance with transfer-learning techniques, thereby facilitating efficient, timely, and robust updating of the AI firmware algorithms.

### BACKGROUND

The present application relates to computing, and more specifically to software and accompanying systems and methods for selectively updating software and/or firmware of a computing environment, such as firmware running on distributed embedded devices.

Systems and methods for updating computing systems are employed in various applications, including updating software running on in-vehicle computers used by law enforcement; updating software and/or firmware running on Internet of Things (TOT) embedded devices; updating mobile devices (e.g., cell phone operating systems); updating Artificial Intelligence (AI) programs running on disparate computers, such as distributed computers of smart cities (e.g., traffic light controllers, light pole camera systems), and so on. Such applications often demand efficient, cost-effective, and robust fault-tolerant updating mechanisms.

Efficient, cost-effective, and robust updating systems and methods can be particularly important for updating AI software applications of in-car computer systems and associated embedded devices, which often require multiple updates throughout their life cycles. Conventionally, updating software and/or firmware may involve replacement of existing programs with updated new programs. However, as embedded devices proliferate, the updating of accompanying AI programs can become increasingly problematic and costly.

Accordingly, instead of replacing existing programs, modern software orchestrators and management systems may implement updates using a centralized network, whereby updates are distributed, e.g., Over The Air (OTA), from a central network source. However, such methods can also require the installation of complete package updates during a particular updating process. This requirement can result in undesirably extend times between updates (as the package updates are assembled and delivered) and can be relatively prone to failure. For example, if the central system (used to distribute updates) goes offline, the updating process may not complete and/or may introduce other problems to devices undergoing updating or upgrading.

### SUMMARY

An example method facilitates updating AI programs running on disparate distributed computing devices, such as embedded devices or systems, using, in part, peer-to-peer networking. The peer-to-peer networking enables AI program updates to be determined by individual computing devices. The updates are then shared with other such devices participating in the peer-to-peer network.

Client software modules are installed on each computing device to facilitate the peer-to-peer sharing of updates and update computation tasks. The client software may also include code for selectively further adjusting or filtering received or transmitted updates based on local context information, e.g., network status, device location information, etc., before applying the updates to the local AI program.

Generally, the example method for updating AI programs using a network includes using a first node of a network of distributed intercommunicating nodes to obtain training data that is usable to train a first AI program running on or in communication with the first node; employing the training data to determine one or more updates to the first AI program; propagating the one or more updates to one or more other nodes of the distributed network, resulting in propagated updates; and updating one or more other AI programs running on the one or more additional nodes with the propagated updates.

In a more specific embodiment, the first AI program includes a Neural Network (NN) (e.g., a deep learning recurrent NN) with one or more layers of NN cells (also called artificial neurons) characterized by one or more weights (associated with input synapses to the cells). The one or more layers of NN cells include one or more classification layers. The propagated updates include updates to one or more values of the one or more weights of the NN cells of the classification layers. Each of the one or more other nodes may incorporate a mechanism to selectively adjust the updates based on local context information, such as location information.

The network may include or represent a peer-to-peer network. The one or more of the intercommunicating nodes represent peers of the peer-to-peer network. In certain implementations, a well-generalized supervisor node, which may be equipped with additional computing power, may facilitate administering, configuring, and updating nodes of the peer-to-peer network.

The step of updating may further include using an updater client program running on the distributed intercommunicating nodes to implement transfer learning to facilitate incorporating the one or more propagated updates into the one or more other artificial intelligence programs.

The step of using may further include receiving input (e.g., from a UI controlled by an operator) to the first node, wherein the input indicates an error in an output of the first AI program; using the error to provide an error signal to a first NN trainer of the first NN program; and using the error signal to determine the one or more updates. Alternatively, or in addition, raw training data may be provided to one or more of the nodes, which can then determine error signals (and associated cost functions or loss scores) used to compute updates to NN weights. The updates can then be shared among network peer nodes.

The step of receiving may further include receiving input from a UI used by an operator, wherein the input identifies the error in an output of the first AI program. The nodes may be implemented, in part, via the updater clients installed on distributed intercommunicating embedded systems, such as in-car computing devices used by law enforcement; used for in semi-autonomous or autonomous vehicle control, or other tasks.

In a more specific embodiment, the one or more embedded systems include one or more Automated License Plate Recognition (ALPR) systems, and the first AI program and the one or more other AI programs are implemented in firmware running on the one or more embedded systems.

Hence, various embodiments discussed herein can use peer-to-peer networking to share not only computing resources (e.g., resources used to calculate NN weight updates based on training set data and/or based on error signals, and using cost function calculation and backpropagation techniques) but software and/or firmware updates. This helps to minimize upgrade footprint when AI pipelines are deployed to a network edge. Furthermore, software of the disparate computing devices can be incrementally updated in the field, without requiring obtaining and installing complete package updates.

Furthermore, updates can be more precisely and accurately configured in accordance with location information or other network context. For example, network parameters (e.g., including NN weights) can be modified based on in which state (e.g., CA, NV, etc.) a particular ALPR system is located.

Accordingly, devices can perform local training, e.g., using transfer learning techniques and using locally (and/or remotely) acquired training data and feedback from operators. Devices can update their own systems and local networks, and can also send weight updates to other devices of their peer-to-peer network.

Accordingly, computing overhead required to implement updates can be distributed across the network, as can the incremental firmware updates. Computing overhead may be further reduced by transferring only NN classification layer weights when implementing certain updates or upgrades.

Use of peer-to-peer networking to facilitate updating computing systems and accompanying AI programs helps to further ensure cost-efficient and robust updating processes, e.g., by removing the central point of failure (e.g., corresponding to a central server that is conventionally relied upon to issue software updates to networked computing devices). If one or more nodes of the peer-to-peer network go offline, the remaining nodes may still implement the updating process among themselves.

The efficiency of the updating process is further enhanced by mechanisms (e.g., including code running in the updater client) that adapt the network updating behavior to network constraints or other context information, such as information about device network connectivity, and application specifics.

A further understanding of the nature and the advantages of particular embodiments disclosed herein may be realized by reference of the remaining portions of the specification and the attached drawings.

### BRIEF DESCRIPTION OF THE DRAWINGS

FIG. 1 illustrates a first example system and accompanying computing environment enabling use of in-device training and peer-to-peer networking to facilitate incremental updates of Artificial Intelligence (AI) software and/or firmware running on embedded devices or systems.

FIG. 2 illustrates additional details of an example mobile computing device and accompanying embedded system, which acts as a node for implementing transfer learning and the sharing of updates between other nodes of the peer-to-peer network of FIG. 1.

FIG. 3 illustrates a second example system and accompanying computing environment, where a portion of a larger peer-to-peer network has been separated from the larger peer-to-peer network, and wherein the separated portion acts as a mesh network usable to share incremental AI updates between participants of the mesh network.

FIG. 4 is a flow diagram of an example method that may be implemented via the embodiments of FIGS. 1-3.

FIG. 5 is a general block diagram of a system and accompanying computing environment usable to implement the embodiments of FIGS. 1-4.

FIG. 6 is a general block diagram of a computing device usable to implement the embodiments of FIGS. 1-5.

### DETAILED DESCRIPTION OF EMBODIMENTS

For the purposes of the present discussion, a networked computing environment may be any computing environment that includes intercommunicating computers, i.e., a computer network, such as a local area network (LAN), wide area network (WAN, e.g., the Internet), cloud infrastructure and services, etc. Similarly, a networked software application may be computer code that is adapted to facilitate communicating with or otherwise using one or more computing resources, e.g., servers, via a network.

Note that collections of computing resources, e.g., computer systems that may intercommunicate via a network of the ecosystem, are called nodes herein. A given node may include software for intercommunicating with other nodes and selectively sharing data; for ensuring conformance with rules of the ecosystem, and so on, thereby enabling implementation of a peer-to-peer ecosystem.

For the purposes of the present discussion, a peer-to-peer network or ecosystem may be any collection of computing resources, e.g., computer systems and/or software applications, i.e., nodes, which are distributed across a computer network, and which may intercommunicate to facilitate sharing process workloads and/or data (e.g., pertaining to AI program updates).

Note that conventionally, peers or nodes of a peer-to-peer network have similar privileges to access data and functionality provided by the network. However, as the term is used herein, peers or nodes of a peer-to-peer network need not be similarly privileged. For example, some nodes, called full nodes or supervisor nodes, may be maximally privileged, i.e., may maintain privileges to control, configure, or otherwise administer the peer-to-peer network and associated behaviors. Note that the terms “peer-to-peer network” and “peer-to-peer ecosystem” may be employed interchangeably herein.

For the purposes of the present discussion, software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a computing object, implementing backpropagation of a cost function to determine neural network weights, and so on.

A node may be implemented via any computer system and/or software application and/or software system, or groups thereof that are coupled to a network. A given node may be allocated different privileges in a given computing environment or ecosystem. Nodes with similar privileges, as it pertains to implementation of one or more particular tasks, are called peers for the purposes of completing the tasks. Note that a peer-to-peer ecosystem may be any ecosystem or computing environment implemented, at least in part, via one or more distributed or networked software applications implemented via different nodes or peers of the ecosystem.

Various example embodiments discussed herein are implemented via a peer-to-peer ecosystem that includes nodes with AI updater clients, as discussed more fully below. The nodes may run various software applications, including AI programs, AI trainer modules, databases, and so on.

An AI program may be any software, firmware, and/or other combination of computer code used to implement one or more AI algorithm. An AI algorithm may be any method implemented via a computer that learns or otherwise uses problem solving so as to facilitate implementing a given function.

In various embodiments discussed herein, the learning can include so-called transfer learning and deep machine learning. For the purposes of the present discussion, transfer learning may be any process or method involving reuse of AI program parameters, data, or other characteristics, such as training data, feature classifications, neural network cell layering architectures, neural network weights, training methods, loss function (also called cost function herein) calculation methods, backpropagation techniques, or other properties of one or more preexisting neural networks.

Note that generally, AI programs used with specific embodiments discussed herein employ one or more Neural Networks (NNs). A neural network may be any computing architecture that includes connected units (called artificial neurons or cells) that model, at least in part, brain neurons. Connections (also called edges) between the units may model brain neurological connections, i.e., synapses. Signals transmitted across connections, i.e., signals output from one cell, and input to another, are processed by receiving cells. The signals input to the receiving cells are multiplied or otherwise modified by weights.

In certain NN implementations, a given cell computes a non-liner function of the sum of its input signals. Weights applied to connections, i.e., edges or synapses, between artificial neurons can be adjusted as learning proceeds. Weights selectively modify signal strength at a given input to a cell.

NN cells are often arranged in different layers, e.g., input layers, output layers, and so-called hidden layers therebetween. Different layers may implement different functions. A layer that performs a classification function is called a classification layer or classifier. Generally, a classification function may be any function that uses inputs to determine a category or group for the received inputs.

A recurrent neural network may be any neural network with cycles and/or feedback loops, such that prior outputs by the network and/or one or more cells or components thereof are fed back as input to the one or more cells, components, and/or to the network itself. Recurrent neural networks can often be graphically visualized by a process called unfolding the network in time, which can assist in manually calculating weight/parameter adjustments during a process called backpropagation in time, whereby the weights/parameters are iteratively adjusted to selectively reduce errors in outputs (also called answers) produced by the neural network.

For the purposes of the present discussion, a computing environment may be any collection of computing resources used to perform one or more tasks involving computer processing. A computer may be any processor in communication with a memory. A computing resource may be any component, mechanism, or capability or quantities thereof of a computing environment, including, but not limited to, processors, memories, software applications, user input devices, and output devices, servers, and so on. Examples of computing resources include data and/or software functionality offered by one or more web services, Application Programming Interfaces (APIs), etc.

A given software application may include (but not necessarily) constituent software applications or modules (e.g., services, functions, procedures, computing objects, etc.). Accordingly, the term “software application” may also include networked software applications or integrated groups thereof. The terms “software application” and “program” are used interchangeably herein.

For clarity, certain well-known components, such as hard drives, processors, operating systems, power supplies, routers, Internet Service Providers (ISPs), and so on, are not necessarily explicitly called out in the figures. However, those skilled in the art with access to the present teachings will know which components to implement and how to implement them to meet the needs of a given implementation.

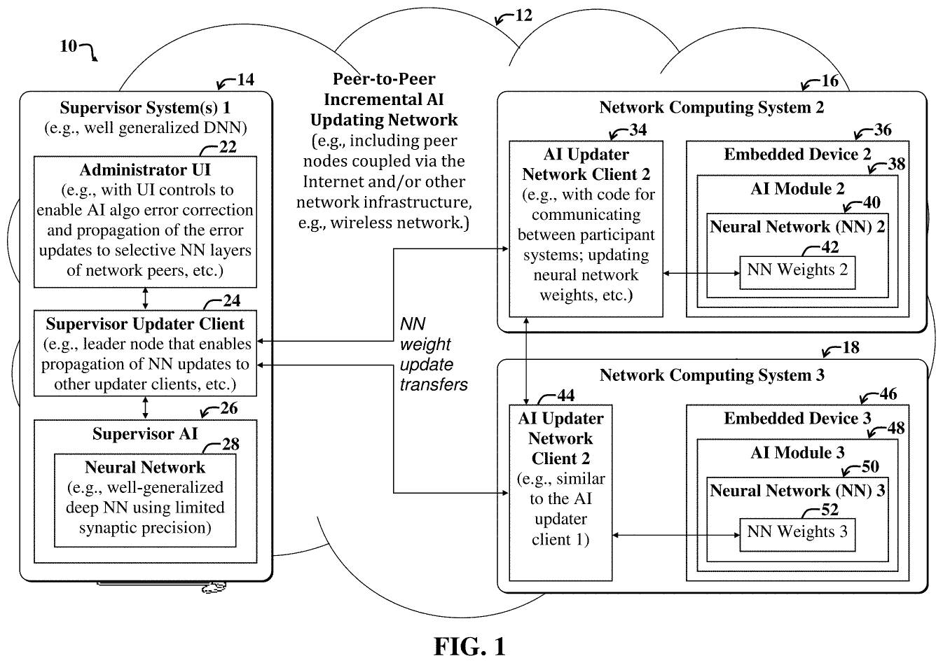

FIG. 1 illustrates a first example system 10 and accompanying computing environment enabling use of in-device training and peer-to-peer networking to facilitate incremental updates of Artificial Intelligence (AI) software and/or firmware running on embedded devices or systems 14-18. The example system 10 includes multiple intercommunicating nodes 14-16 of a peer-to-peer network 12, which may be implemented, in part, via the Internet and/or other network infrastructure (e.g., wireless network).

The example peer-to-peer network 12 may represent an incremental AI updating network, which enables relatively small, yet frequent, updates to AI programs 26, 40, 50. The updates may involve, for example, updates (e.g., NN weight adjustments) to only specific layers (e.g., classification layers) of NNs 28, 42, 52 of the AI programs 26, 40, 50, as discussed more fully below.

The example system 10 includes one or more supervisor systems or nodes 14 in communication with other nodes, e.g., a second node 16 and a third node 18 at a network edge. For the purposes of the present discussion, a supervisor node may be any network node that implements functionality for administrating, governing, or otherwise controlling one or more other nodes of the network. The nodes 14-18 are called edge nodes herein, as they exist at the edge of the network 12, i.e., they represent entry points or systems to the network 12, i.e., points where data can be input to the network 12 and/or retrieved therefrom.

The first example supervisor system or node 14 includes an administrator User Interface (UI) 22 in communication with a supervisor updater client 24. The supervisor updater client 24 communicates with a supervisor AI program 26 (also simply called a “supervisor AI”), which includes a well-generalized deep neural network 28. The supervisor NN 28 may use Limited (synaptic) Precision (LP) for synaptic NN weights, whereby relatively low bit counts (for digital implementations) are used for the weights. This may enhance NN performance, e.g., by reducing the number of clock cycles required per processing stage. An NN is said to be well generalized if it is not over trained or curve fit to training data.

The administrator UI 22 may include rendering instructions for rendering one or more UI display screens with one or more UI controls for enabling an operator, e.g., administrator, to observe errors in the output of the supervisor AI module 26 and to notify the supervisor updater client 24 of any noticed or flagged errors. The supervisor updater client 24 may then facilitate using the error and/or associated data as training data, such that the resulting error can be used to compute a cost function (e.g., via cross-entropy loss scoring). The cost function is then used to implement backpropagation to determine new values for NN weights for the synapses of the accompanying NN 28.

One or more of the newly computed weights (i.e., weight updates) can then be propagated to the other network nodes 16, 18. Note that alternatively, the supervisor updater client 24 implements functionality that enables the error signal and/or training set data to be forwarded to one or more of the other nodes 16, 18. One of the other nodes 16, 18 may then perform the cost function computation using the error signal and/or new training set data, so as to enable backpropagation and determination of weight updates for the NNs 28, 40, 50 of the nodes 14-18 of the peer-to-peer network 12.

In the present example embodiment, each of the nodes 14-18 includes a respective updater client 24, 34, 44, which includes code for intercommunicating via the network 12; including sharing computation loads (required to calculated NN weight updates) and resulting AI program weight adjustments or updates, e.g., updates to NN weights 42, 52. The nodes 14-18 also include respective AI programs 26, 38, 48 and accompanying NNs 28, 40, 50.

For illustrative purposes, the second node 16 (i.e., network computing system) is shown running the second AI program or module 38 on an embedded device 36 that communicates with a second AI updater client 34. Similarly, the third node 18 runs a third AI program 48 on a third embedded device 46, which communicates with a third updater network client 44.

For the purposes of the present discussion, an embedded device may be any device or computer that is specialized for a particular task or function, and which may be included (or embedded) as part of a larger computing system. For example, the second and third AI programs 38, 48 may be specialized to perform Automated License Plate Recognition (ALPR), and embedded as part of larger respective computing systems 16, 18, as discussed more fully below.

The embedded devices 36, 46 may be implemented via specialized computers. For example, the embedded devices 36, 46 may be implemented via NVidia Jetson TX2 AI modules or other technology that is suitable to meet the needs of a given implementation.

Note that in general, groupings of various modules of the system 10 are illustrative and may vary, e.g., certain modules may be combined with other modules or implemented inside of other modules, or the modules may otherwise be distributed differently (than shown) among a network or within one or more computing devices or virtual machines, without departing from the scope of the present teachings. For example, in certain implementations, the AI updater network clients 34, 44, may be included in their respective embedded devices 36.

Note that, in certain implementations, one or more of the computing systems 14-18 need only propagate or share corrections, i.e., updates to weights of the NNs 28, 40, 50 with each other, which may require minimal network overhead (e.g., bandwidth, computing resources, etc.).

Furthermore, computing resources used to compute weight updates can be shared or distributed among nodes 14-18 of the peer-to-peer network 12. For example, only one of the nodes 14-18 needs to calculate weight adjustments for the other nodes to be subsequently updated thereby. The computing resources used to calculate the backpropagation adjustments (e.g., weight adjustments, etc.), can also be used to forward the results of the backpropagation calculations to other nodes, thereby saving computing resources on the other nodes.

While in the present example embodiment, the supervisor system 14 is discussed as having extra computing resources for calculating the updates to share with the other nodes 16, 18, embodiments are not limited thereto. Depending upon details of a particular implementation, any of the network nodes 14-18 can act as a supervisor node, or, alternatively, none of the network nodes 14-18 need to act as supervisor nodes or be differently privileged relative to each other.

Furthermore, note that while the supervisor system 14 is discussed as having different privileges (e.g., network administrator privileges), the network 12 is still considered to represent a peer-to-peer network 12, as at least part of the network 12 includes intercommunicating peers 16, 18. Furthermore, the supervisor system 14 may also be considered to represent a peer of the other computing systems 16, 18 to the extent that all of the systems or nodes 14-18 may be privileged to compute and share updates with other nodes.

Furthermore, note that by distributing AI program update calculations and sharing resulting weight adjustments among nodes of the peer-to-peer network 12, enhanced fault tolerance over conventional more centralized updating systems and methods is achieved. Use of the peer-to-peer network 12 to facilitate incremental AI program updates results in removal of the conventional central point of failure associated with centralized software and/or firmware updating networks.

Furthermore, use of the peer-to-peer network 12 facilitates other synergistic functions and adaptations, such as load balancing functions. For example, in certain implementations, when computing resources of one or more of the nodes 15-18 are running low, the nodes 15-18 may leverage the peer-to-peer network 12 as a distributed compute cloud, whereby computing tasks can be offloaded to other nodes, which can then perform calculations and return results on behalf of the compromised node(s).

Computer code for implementing such functionality, e.g., load balancing, adaptations to network parameters (e.g., network status or connectivity information), etc., may be implemented as part of the updater client code 24, 34, 44.

Furthermore, note that the efficiency, reliability, and/or accuracy of software update propagation can be further enhanced by adapting network and node behaviors based on network connectivity, node location, and other device or network context information. For example, in certain implementations, the AI updater clients 24, 34, 44, may run code for accessing device location information, and making any additional adjustments to received weight updates, if the operations of the AI modules 26, 38, 48 are affected by or are a function of device location, as discussed more fully below.

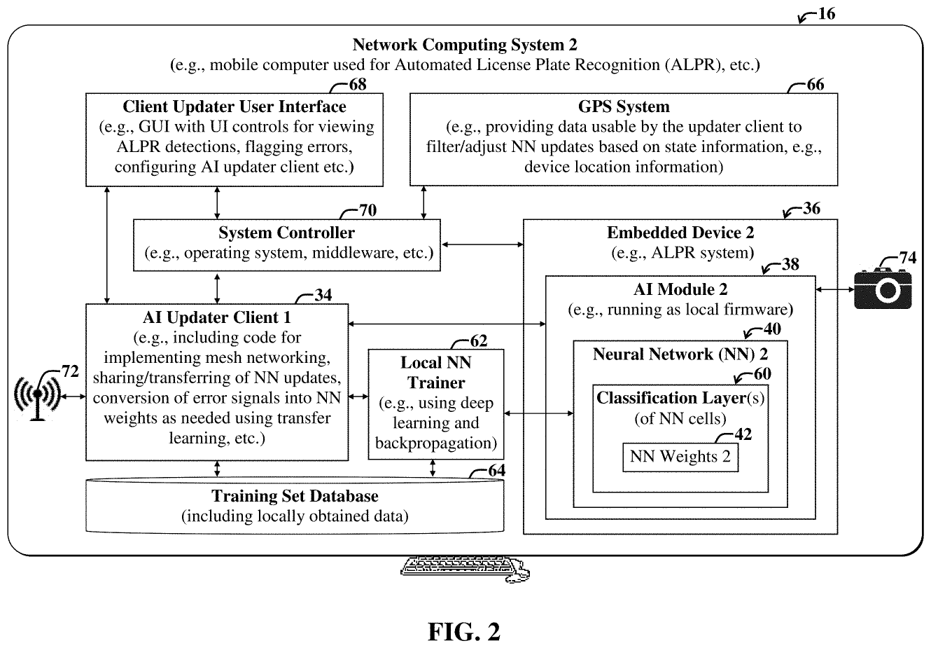

FIG. 2 illustrates additional details of an example mobile computing device or system 16 and accompanying embedded system 36, which acts as a node for implementing transfer learning and the sharing of updates between other nodes 14, 18 of the peer-to-peer network 12 of FIG. 1.

The example computing system 16 includes the AI updater client 34 in communication with the embedded device 36, a client updater UI 68, a training set database 64, a local neural network trainer 62, and a system controller 70. The system controller 70 includes code, e.g., operating system, middleware, etc., for facilitating selectively interfacing and routing communications between various modules 34, 36, 66, 68 of the computing system 16. The updater client 34 can also communicate with a GPS system 66, e.g., via the system controller 70, so as to obtain device location information, as discussed more fully below.

The training set database 64 includes example inputs with predetermined accurate outputs that the NN 40 should produce when supplied with the inputs. The local NN trainer 62 includes code for using training data to measure divergences between the known values for accurate outputs (given the training inputs) and actual outputs provided by the AI module 38. The divergences or error signals are then used to calculate a cost function value (or loss score), which is then used for backpropagation calculations. The backpropagation calculations yield adjustments to be made to the NN weights 42 of the classification layers 60.

Note that while the local NN trainer 62 is shown separately from the AI updater client 34 and AI module 38, that in practice, the groupings may differ from that shown in FIG. 2. For example, in certain implementations, the local NN trainer 62 may be implement as part of the AI updater client 34, and both the trainer 62 and AI updater client 34 may be installed on the embedded device 36 along with (or as part of) the AI module 38.

Training data stored in the training database 64 may include locally obtained training data, and/or training data obtained from one or more other nodes of the associated peer-to-peer network (e.g., the peer-to-peer network 12 of FIG. 1). The training set database 64 may also maintain a record of updates to the NN weights 42, in addition to calculated error signals.

Locally obtained training data may be obtained, for instance, via user input supplied via the client updater UI 68. For example, if an operator notices an error in output data from the AI module 38, the operator may employ the client updater UI 68 to flag the error and enter a correction. The corrected answer, along with the incorrect answer and input that resulted in the AI module 38 outputting the incorrect answer, can represent training data usable by the local NN trainer 62 to determine updates to the NN weights 42 of the NN classification layers 60.

In the present example embodiment, the computing system 16 supports an embedded device 36 that is adapted to perform Automated License Plate Recognition (ALPR) using an AI program 38 with a neural network 40. The ALPR AI module 38 may be used in, for example, law enforcement vehicles (e.g., police cars).

The NN 40 includes multiple layers of artificial neurons or cells, including one or more classification layers 60. To update the NN 40, only weights 42 of the classification layers 60 are to be updated. Note however, that weights of other NN layers may be also be updated, without departing from the scope of the present teachings.

The ALPR AI module 38 implements functionality for analyzing video data from a video camera 74 and detecting and reading license plates. The NN weights 42 are adjusted to improve the performance and ability of the AI module 38 to accurately detect license plates in video data and to provide associated license plate numbers to other programs that may be running on the network computing system 16.

Note that the AI module 38 may be implemented via specialized firmware that is particularly specialized to read and process video data output from the video camera 74. For the purposes of the present discussion, firmware may be any software that provides control functionality for hardware (e.g., the camera 74).

In the present example embodiment, the GPS system 66 provides location information that is accessible to the AI updater client 34. The location information may indicate, for instance, in which geographic state the computing device 16 is located. Different states may have different license plate features, which may affect values for the NN weights 42. Accordingly, updates to the weights 42 received from out-of-state nodes may be modified by corrective factors to account for differences in license plate characteristics between states, before the updated weights are applied to adjust the NN weights 42. Such modification or filtering can be performed by code and associated functionality implemented via the AI updater client 34.

Updates to the NN weights 42, including any filters applied thereto, can be shared with local (e.g., in the same state) similar AI modules 38, e.g., using a wireless transceiver 72.

In summary, AI software and/or firmware of a peer-to-peer network can be updated using in-device learning features, whereby results of locally performed training can be transferred to other participant nodes of the peer-to-peer network; thereby implementing a form of transfer learning. Local training data can be obtained from operators of the computing system 16, or in certain implementations, such as unsupervised learning implementations, can be obtained by the AI module 38 itself as it analyzes video data output from the camera 74.

Accordingly, computing devices, such as the computing system 16 can update themselves and their associated networks, resulting in robust, efficient, and cost-effective updating operations. Different instances or versions of the computing system 16 may be deployed in clusters of embedded in-car mobile devices.

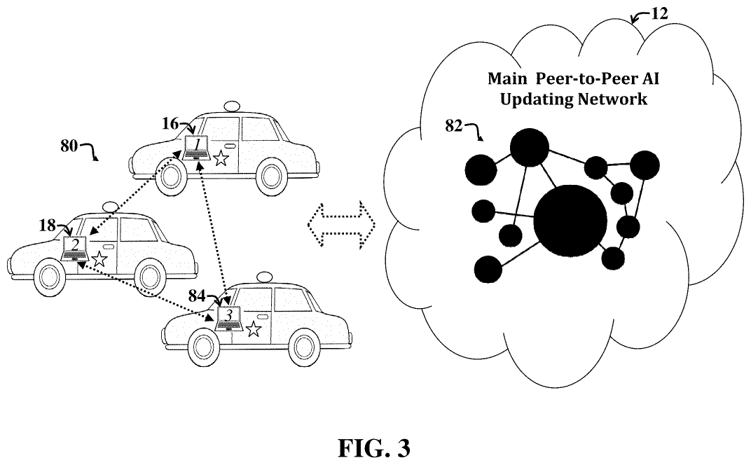

FIG. 3 illustrates a second example system 80 and accompanying computing environment, where a portion 80 of a larger peer-to-peer network 12 has been separated from the larger peer-to-peer network 12 and accompanying nodes 82. The separated portion 80 acts as a mesh network that is usable to share incremental AI updates between participant nodes 16, 18, 84 of the mesh network 80.

For the purposes of the present discussion, a mesh network may be any local network topology where the accompanying nodes communicate directly, as opposed to via the Internet. In such a network, the nodes 16, 18, 84 may also participate in relaying information among themselves as needed.

When the nodes 16, 18, 84 get cutoff from the main network 12, e.g., due to network outages, etc., they may then begin to intercommunicate and share updates (and computing resources used to compute the updates) among themselves. This functionality for detecting such conditions and converting local nodes 16, 18, 84 into the mesh network 80 can be implemented via accompanying updater clients included in the nodes 16, 18, 84 in accordance with network status information detected by the accompanying embedded devices.

When the network connection (e.g., Internet connection) is reestablished, the mesh network 80 may then rejoin the broader network 12 and synchronize updates determined by the mesh network 80 with any updates made by the broader network 12.

Exact details as to how updates should be synchronized (when the mesh network 80 reconnects with the broader network 12) are implementation specific and may vary, without departing from the scope of the present teachings. Nevertheless, in certain implementations, for example, the nodes 16, 18, 84 of the mesh network 80 and the nodes 82 of the broader network 12 maintain a historical record of weight updates. And, when the mesh network 80 rejoins with the broader network 12, whichever node has made the most updates or has otherwise demonstrated more accurate performance (e.g., based on detected or measured error rate), may be used to further update the other nodes.

In summary, updater client modules installed on fleets of vehicles can enable peer-to-peer mesh networking in a limited circle of peers during broader network failure. When a given mesh network reconnects to the broader network, then the most recent and/or accurate updates by a given mesh can be used to update other peers.

A vehicle fleet, such as a fleet of police cars, may host computer systems with intercommunicating updater modules used to update firmware AI programs or modules. The peer-to-peer clients are installed on the local computer systems and granted access to update weights of the accompanying neural network participant nodes. The AI modules may run on dedicated Application Specific Integrated Circuits (ASICs) or embedded devices, such that computing resources of any accompanying larger computing system are not consumed when implementing fast calculations needed by certain AI programs to generate accurate outputs.

The client modules can access local GPS signaling and can update NN weights based, in part, on which state the police vehicle is operating in (e.g., CA, AZ, etc.). Additional benefits that can be afforded via use of embodiments discussed herein include efficient load balancing and distribution of computing resources being shared. When one node is updated with weights, e.g., using backpropagation responsive to a correction sent by a supervisor, the weight adjustments can be shared among peers.

The computing resources used to calculate the backpropagation adjustments (e.g., weight updates, etc.) can forward the results of the backpropagation calculations to other nodes, thereby saving computing resources on the other nodes.

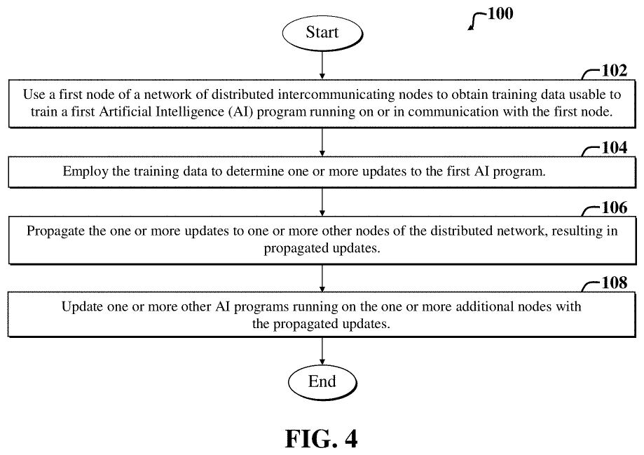

FIG. 4 is a flow diagram of an example method 100 that may be implemented via the embodiments of FIGS. 1-3. With reference to FIGS. 1-4, the example method 100 facilitates updating artificial intelligence programs using a network (e.g., the peer-to-peer network 12 of FIG. 1).

A first step 102 includes using a first node (e.g., the supervisor node 14 of FIG. 1) of a network of distributed intercommunicating nodes (e.g., the nodes 14-18 of FIG. 1) to obtain training data usable to train a first Artificial Intelligence (AI) program (e.g., the supervisor AI 26 of FIG. 1) running on or in communication with the first node. The training data may be predetermined data, operator-supplied data (e.g., obtained when operators identify errors in AI program output), etc.

A second step 104 includes employing the training data (which may be maintained, for instance, in the training set database 64 of FIG. 2) to determine one or more updates to the first AI program. Determination of the updates may be facilitated by updater clients (e.g., one or more of the updater clients 24, 34, 44 of FIG. 1) and local AI trainer modules (e.g., the local NN trainer 62 of FIG. 2).

A third step 106 includes propagating the one or more updates to one or more other nodes (e.g., the nodes 16, 18) of the distributed network, resulting in propagated updates. Propagation of updates may be facilitated by peer-to-peer networking functionality implemented in the updater clients 24, 34, 44 of FIG. 1.

A fourth step 108 includes updating one or more other AI programs (e.g., the AI programs 38, 48 of FIG. 1) running on the one or more additional nodes with the propagated updates.

Note that the example method 100 may be altered, without departing from the scope of the present teachings. Certain steps may be reordered, removed, augmented, or replaced with other steps, without departing from the scope of the present teachings.

For example, the method 100 may further specify that the first AI program includes a Neural Network (NN) with one or more layers (e.g., as represented by the layers 60 of FIG. 2) of NN cells characterized by one or more weights (e.g., the NN weights 42 of FIG. 2).

The one or more layers of NN cells may include one or more classification layers. The propagated updates may include updates to one or more values of the one or more weights. Each of the one or more other nodes may incorporate a mechanism (e.g., a filtering mechanism implemented by the updater clients 34, 44) to selectively adjust the updates based on local context information (e.g., GPS information provided via the GPS system 66 of FIG. 2).

The example method 100 may further specify that the network includes or represents a peer-to-peer network, and that the one or more of the intercommunicating nodes represent peers of a=the peer-to-peer network.

The first node may represent a supervisor node (e.g., the supervisor node 14 of FIG. 1). The method 100 may further include implementing the one or more network nodes using one or more embedded devices at a network edge, i.e., edge of the peer-to-peer network.

The fourth step 108 may further include using an updater client running the distributed intercommunicating nodes, wherein the updater client uses transfer learning to facilitate incorporating the one or more propagated updates in the one or more other artificial intelligence programs.

The first step 102 may further include receiving input to the first node, wherein the input indicates an error in an output of the first AI program; using the error to provide an error signal to a first NN trainer of the first NN program; and using the error signal to determine the one or more updates. The receiving of input may include receiving input from a UI used by an operator, wherein the input identifies an error in an output of the first AI program.

The example method 100 may further include using one or more embedded systems (e.g., corresponding to the embedded devices 36, 46 of FIGS. 1 and 2) to implement one or more nodes of the distributed intercommunicating nodes, including the one or more other nodes. The one or more embedded systems may include one or more Automated License Plate Recognition (ALPR) systems (e.g., corresponding to the AI module 38 of FIG. 2). The first AI program and the one or more other AI programs may be implemented in firmware running on the one or more embedded systems.

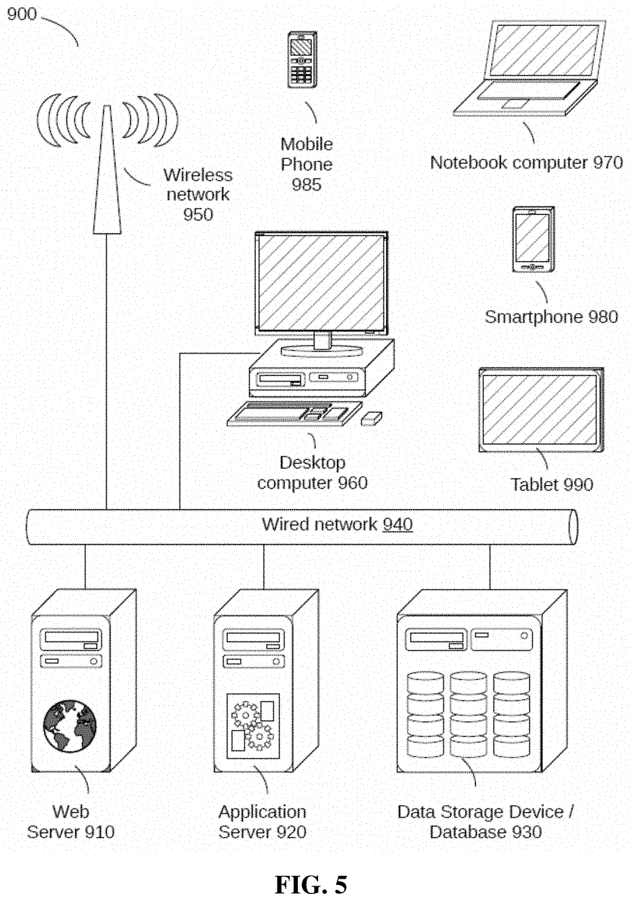

FIG. 5 is a general block diagram of a system 900 and accompanying computing environment usable to implement various embodiments discussed herein. For example, the example system 900 is usable to implement the example embodiments of FIGS. 1-4. Embodiments may be implemented using standalone applications (for example, residing in a user device) and/or using web-based applications implemented using a combination of client-side and server-side code.

The general system 900 includes user devices 960-990, including desktop computers 960, notebook computers 970, smartphones 980, mobile phones 985, and tablets 990. The general system 900 can interface with any type of user device, such as a thin-client computer, Internet-enabled mobile telephone, mobile Internet access device, tablet, electronic book, or personal digital assistant, capable of displaying and navigating web pages or other types of electronic documents and UIs, and/or executing applications. Although the system 900 is shown with five user devices, any number of user devices can be supported.

A web server 910 is used to process requests from web browsers and standalone applications for web pages, electronic documents, enterprise data or other content, and other data from the user computers. The web server 910 may also provide push data or syndicated content, such as RSS feeds, of data related to enterprise operations.

An application server 920 operates one or more applications. The applications can be implemented as one or more scripts or programs written in any programming language, such as Java, C, C++, C#, or any scripting language, such as JavaScript or ECMAScript (European Computer Manufacturers Association Script), Perl, PHP (Hypertext Preprocessor), Python, Ruby, or TCL (Tool Command Language). Applications can be built using libraries or application frameworks, such as Rails, Enterprise JavaBeans, or .NET. Web content can created using HTML (HyperText Markup Language), CSS (Cascading Style Sheets), and other web technology, including templating languages and parsers.

The data applications running on the application server 920 are adapted to process input data and user computer requests and can store or retrieve data from data storage device or database 930. Database 930 stores data created and used by the data applications. In an embodiment, the database 930 includes a relational database that is adapted to store, update, and retrieve data in response to SQL format commands or other database query languages. Other embodiments may use unstructured data storage architectures and NoSQL (Not Only SQL) databases.

In an embodiment, the application server 920 includes one or more general-purpose computers capable of executing programs or scripts. In an embodiment, web server 910 is implemented as an application running on the one or more general-purpose computers. The web server 910 and application server 920 may be combined and executed on the same computers.

An electronic communication network 940-950 enables communication between user computers 960-990, web server 910, application server 920, and database 930. In an embodiment, networks 940-950 may further include any form of electrical or optical communication devices, including wired network 940 and wireless network 950. Networks 940-950 may also incorporate one or more local-area networks, such as an Ethernet network, wide-area networks, such as the Internet; cellular carrier data networks; and virtual networks, such as a virtual private network.

The system is one example for executing applications according to an embodiment of the invention. In another embodiment, application server 910, web server 920, and optionally database 930 can be combined into a single server computer application and system. In a further embodiment, virtualization and virtual machine applications may be used to implement one or more of the application server 910, web server 920, and database 930.

In still further embodiments, all or a portion of the web and application serving functions may be integrated into an application running on each of the user computers. For example, a JavaScript application on the user computer may be used to retrieve or analyze data and display portions of the applications.

With reference to FIGS. 1 and 8, the computing systems 14-18 of FIG. 1 may be implemented via one or more of the user computers 960-990 of FIG. 5. The wired network 940 may provide infrastructure for facilitating intercommunications between the peers 14-18 of the peer-to-peer network 12 of FIG. 1.

The application server 920 may be used to serve software for local installation, wherein the software may include AI updater clients 24, 34, 44 of FIG. 1 for installation on the respective computing system nodes 14-18. Users of the nodes 14-18 of FIG. 1 may browse to a website hosted by the web server 910, e.g., so as to obtain links to download the peer-to-peer client software for incrementally updating AI programs. The data storage device database 930 may store installation packages for the client software and may also store AI training set data, histories of NN weight updates, and so on.

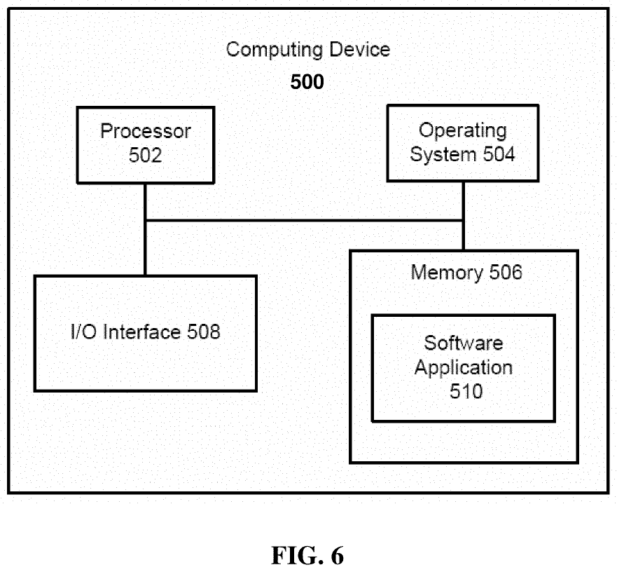

FIG. 6 is a general block diagram of a computing device usable to implement the embodiments of FIGS. 1-3. While system 500 of FIG. 6 is described as facilitating performing the steps as described in certain implementations herein, any suitable component or combination of components of system 500 or any suitable processor or processors associated with system 500 may be used for performing the steps described.

FIG. 6 illustrates a block diagram of an example computing system 500, which may be used for implementations described herein. For example, computing system 500 may be used to implement server devices 910, 920 of FIG. 5 as well as to perform the method implementations described herein.

In some implementations, computing system 500 may include a processor 502, an operating system 504, a memory 506, and an input/output (I/O) interface 508. In various implementations, processor 502 may be used to implement various functions and features described herein, as well as to perform the method implementations described herein. While processor 502 is described as performing implementations described herein, any suitable component or combination of components of system 500 or any suitable processor or processors associated with system 500 or any suitable system may perform the steps described. Implementations described herein may be carried out on a user device, on a server, or a combination of both.

Computing device 500 also includes a software application 510, which may be stored on memory 506 or on any other suitable storage location or computer-readable medium. Software application 510 provides instructions that enable processor 502 to perform the functions described herein and other functions. The components of computing system 500 may be implemented by one or more processors or any combination of hardware devices, as well as any combination of hardware, software, firmware, etc.

For ease of illustration, FIG. 6 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various implementations, computing system 500 may not have all of the components shown and/or may have other elements including other types of components instead of, or in addition to, those shown herein.

Although the description has been described with respect to particular embodiments thereof, these particular embodiments are merely illustrative, and not restrictive. For example, while embodiments are discussed with respect to updating of Artificial Intelligence (AI) firmware of embedded devices, such as Automated License Plate Recognition (ALPR) systems, embodiments are not limited thereto. Other types of devices and software may be readily updated using systems and methods discussed herein without departing from the scope of the present teachings.

Furthermore, while various embodiments discussed herein employ supervised learning and locally obtained or supplied training set data, that embodiments are not limited thereto. Embodiments may be readily adapted to facilitate updating AI programs that also (or alternatively) leverage unsupervised learning to train accompanying NNs.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating updating artificial intelligence programs using a network, the method comprising:
using a first node of a network of distributed intercommunicating nodes to obtain training data usable to train a first Artificial Intelligence (AI) program running on or in communication with the first node;
employing the training data to determine one or more updates to the first AI program;
propagating the one or more updates to one or more other nodes of the distributed network, resulting in propagated updates; and
updating one or more other AI programs running on the one or more other nodes with the propagated updates.

2. The method of claim 1, wherein the first AI program includes a Neural Network (NN) with one or more layers of NN cells characterized by one or more weights.

3. The method of claim 2, wherein the one or more layers of NN cells include one or more classification layers.

4. The method of claim 3, wherein the propagated updates include updates to one or more values of the one or more weights.

5. The method of claim 4, wherein each of the one or more other nodes incorporates a mechanism to selectively adjust the propagated updates based on local context information.

6. The method of claim 5, wherein the local context information includes location information.

7. The method of claim 1, wherein the network includes a peer-to-peer network, and wherein one or more of the distributed intercommunicating nodes represent peers of the peer-to-peer network.

8. The method of claim 7, wherein the first node includes a supervisor node.

9. The method of claim 8, further including implementing one or more of the distributed network nodes using one or more embedded devices at an edge of the peer-to-peer network.

10. The method of claim 1, wherein updating further includes using an updater client running on one or more of the distributed intercommunicating nodes, wherein the updater client includes code for implementing transfer learning to facilitate incorporating the one or more propagated updates into the one or more other AI programs.

11. The method of claim 1, wherein using a first node further includes:
receiving input to the first node, wherein the input indicates an error in an output of the first AI program;
using the error to provide an error signal to a first Neural Network (NN) trainer of the first AI program;
and using the error signal to determine the one or more updates.

12. The method of claim 11, wherein receiving input further includes receiving input from a UI used by an operator, wherein the input identifies an error in an output of the first AI program.

13. The method of claim 11, further including using one or more embedded systems to implement one or more nodes of the distributed intercommunicating nodes, including the one or more other nodes.

14. The method of claim 13, wherein the one or more embedded systems include one or more Automated License Plate Recognition (ALPR) systems.

15. The method of claim 14, wherein the first AI program and the one or more other AI programs are implemented in firmware running on the one or more embedded systems.

16. A non-transitory processor-readable storage device including logic for execution by one or more processors and when executed operable for facilitating propagating software updates to nodes of a network of a computing environment, by performing the following acts:
using a first node of a network of distributed intercommunicating nodes to obtain training data usable to train a first Artificial Intelligence (AI) program running on or in communication with the first node;
employing the training data to determine one or more updates to the first AI program;
propagating the one or more updates to one or more other nodes of the distributed network, resulting in propagated updates; and
updating one or more other AI programs running on the one or more other nodes with the propagated updates.

17. The non-transitory processor-readable storage device of claim 16, wherein using a first node further includes:
receiving input to the first node, wherein the input indicates an error in an output of the first AI program;
using the error to provide an error signal to a first Neural Network (NN) trainer of the first AI program;
and using the error signal to determine the one or more updates.

18. The non-transitory processor-readable storage device of claim 17, wherein receiving input further includes receiving input from a UI used by an operator, wherein the input identifies an error in an output of the first AI program, and further including further including using one or more embedded systems to implement one or more nodes of the distributed intercommunicating nodes, including the one or more other nodes, and wherein the one or more embedded systems include one or more Automated License Plate Recognition (ALPR) systems.

19. The non-transitory processor-readable storage device of claim 17, wherein the first AI program and the one or more other AI programs are implemented in firmware running on the one or more embedded systems.

20. An apparatus comprising:
one or more processors;
logic encoded in one or more non-transitory media for execution by the one or more processors and when executed operable for:
using a first node of a network of distributed intercommunicating nodes to obtain training data usable to train a first Artificial Intelligence (AI) program running on or in communication with the first node;
employing the training data to determine one or more updates to the first AI program;
propagating the one or more updates to one or more other nodes of the distributed network, resulting in propagated updates; and
updating one or more other AI programs running on the one or more other nodes with the propagated updates.
